(19) United States
(12) Patent Application Publication
(10) Pub. No.: US 2011/0153034 A1
(43) Pub. Date: Jun. 23, 2011

(54) UNIVERSAL HUMAN MACHINE INTERFACE FOR AUTOMATION INSTALLATION

(75) Inventors: Keith Philliben, Chesterfield, MI (US); Andrea Zaccaro, Collegno (IT); Daniel McClure, Howell, MI (US); David Wang, Northville, MI (US)

(73) Assignee: COMAU, INC., Southfield, MI (US)

(21) Appl. No.: 12/978,039

(22) Filed: Dec. 23, 2010

Related U.S. Application Data
(60) Provisional application No. 61/289,801, filed on Dec. 23, 2009.

(51) Int. Cl. G05B 15/00

(52) U.S. Cl. 700/17; 700/83

(57) ABSTRACT

Disclosed herein is a method for operating a user interface in an automation installation. The method includes identifying at least one control device, establishing a connection between the user interface and the at least one control device, obtaining at least one user interface parameter from the at least one control device and generating at least one display screen on the user interface using the at least one user interface parameter.

### CROSS REFERENCE TO RELATED APPLICATIONS

This application claims priority to U.S. Provisional Patent Application Ser. No. 61/289,801, filed Dec. 23, 2009, which is incorporated herein in its entirety.

### BACKGROUND

Modern industrial automation environments can employ a series of user interfaces, such as human machine interfaces (HMIs) to, for example, control and/or monitor a control device (or multiple control devices) in an automation installation (e.g., assembly line, chemical processing, material fabrication, or any other system utilizing control devices). Each HMI typically includes a software application specifically programmed to appropriately control and/or monitor a specific control device or group of control devices.

Some large automation installations contain hundreds of different control devices with each control device or group of control devices having, for example, its own HMI. Accordingly, for example, multiple software applications are developed for each particular HMI to account for the specific functions or configuration of its associated control device or group of control devices. Moreover, beyond development, each of these applications are commonly tested, debugged and maintained throughout the life of each HMI on which they are run.

### SUMMARY

Embodiments of a method for operating a user interface in an automation installation are disclosed herein. In one embodiment, the method includes identifying at least one control device and establishing a connection between the user interface and the at least one control device. The method also includes obtaining at least one user interface parameter from the at least one control device and generating at least one display screen on the user interface using the at least one user interface parameter.

Embodiments of a user interface apparatus for use in an automation installation are also disclosed herein. In one embodiment, the apparatus includes a memory and a processor configured to execute instructions stored in the memory to identify at least one control device and establish a connection with the at least one control device. The processor is also configured to execute instructions stored in the memory to obtain at least one user interface parameter from the at least one control device and generate at least one display screen on the user interface using the at least one user interface parameter.

Further, embodiments of an automation system are disclosed herein. In one embodiments the automation system includes at least one control device having at least one user interface parameter. The automation system also includes a user interface configured to accept the at least one user interface parameter from the at least one control device and generate at least one display screen using the at least one user interface parameter. Further, the automation system includes a communications network configured to connect the at least one control device and the user interface.

These and other embodiments will be described in additional detail hereafter.

### BRIEF DESCRIPTION OF THE DRAWINGS

The description herein makes reference to the accompanying drawings wherein like reference numerals refer to like parts throughout the several views, and wherein:

FIG. 1 is a schematic diagram of a single universal HMI utilized in an automation installation according to one embodiment of the invention;

FIG. 2 is a schematic diagram of multiple universal HMIs utilized in an automation installation according to another embodiment of the invention;

FIG. 3 is a schematic diagram of multiple universal HMIs utilized in an automation installation according to another embodiment of the invention; and

FIG. 4 is a flowchart of an exemplary method of utilizing a universal HMI within any of the automation installations illustrated in FIGS. 1-3.

### DETAILED DESCRIPTION

Embodiments of the present invention describe a universal HMI application (“universal application”) which can be executed on one or more HMIs. The universal application may not necessitate any specific configuration or parameterization of the HMI before being utilized in the automation installation. Rather, the universal application is, for example, configured by the control device(s) used within and the specific architecture of the automation installation. In other words, the universal application is tailored (if necessary) to the automation installation and the control devices contained therein once the HMI has been appropriately connected. Once tailored (e.g., configured and parameterized) the universal application can be utilized within the entire automation installation.

Accordingly, by using the universal application, for example, the conventional method of employing multiple HMI software applications in an automation installation (that are specifically tailored to the control devices they are interfaced with) can be eliminated. In other words, one universal application can be developed for each automation installation (or multiple automation installations). The universal application can be designed such that it is robust enough to control and/or monitor all compatible control devices within an automation installation, which can reduce the total number of HMIs used. Furthermore, an operator or skilled technician may only have to be trained to use one HMI, because the application loaded thereon will be the same across all of the HMI(s) within an automation installation.

Regardless of which control device, subset of control devices, or group of control devices is chosen to be controlled and/or monitored, the universal application can provide the same or greater user interface capability to the operator as was available using conventional HMIs. The universal application can be developed so that it operates within the automation installation using, for example, any or all combinations of communication mediums and protocols. Further, all of the available configurations of control devices within an automation installation can be planned for and incorporated within the programming of the universal application. For example, available configurations of control devices within an automation installation can include scope of monitoring and/or control or types and quantity of the control devices to be monitored and/or controlled.

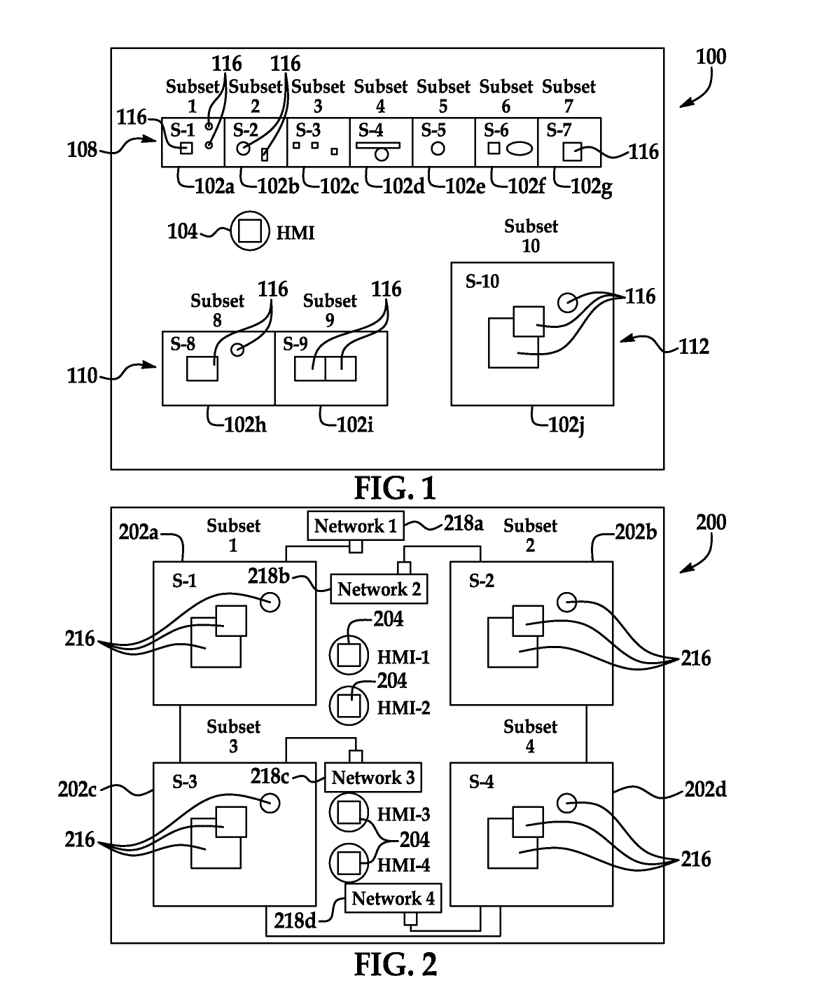

FIG. 1 illustrates an automation installation 100 according to one embodiment of the present invention. The automation installation 100 includes ten subsets 102a-j (collectively referred to as subsets 102) and a HMI 104 having a universal application. The universal application, for example, may not require specific configuration or parameterization before being utilized in the automation installation 100. Rather, the universal application, may, for example, be configured by the control devices or subsets 102 of control devices used within and the specific architecture of the automation installation 100. In some embodiments, the universal application may include general setup information related to network configuration for the control devices (e.g. network type, address scheme, default address, etc.).

The automation installation 100 can include any control device, machine or component, or any collection and combination thereof. The automation installation 100 can be used in the field of manufacturing, assembling, processing, fabricating, producing, or any other field. Non-limiting examples of an automation installation include assembly lines, chemical processing, material fabrication or any other environment utilizing automatic processes.

The HMI 104 can be any device having processing capabilities including a personal computer (PC), industrial PC, handheld PC, tablet PC, personal digital assistant, telephone, data acquisition device or any other device. HMI 104 can include various hardware components including a processor, memory (e.g., ROM, RAM, EEPROM, etc), output devices (e.g., screen display, speakers, etc.) and/or input devices (e.g., keyboard, mouse).

The universal application can be installed, downloaded, flashed, or loaded to HMI 104 or otherwise transferred to HMI 104 using any other suitable means. The universal application as used herein includes an application that can be used to control and/or monitor any or all of the subsets 102 in the automation installation 100. The subsets 102 can be of any size, contain different devices and/or components, have different layouts. Utilizing the universal application, the HMI 104 can display one or more user interface screens configured by control device(s) and is able to interact with each of subsets 102. The HMI 104 can be removable and transportable. However in some instances fixed HMIs, as opposed to HMIs that are removable and transportable, can be used for controlling and/or monitoring subsets 102.

Each of the subsets 102 can be part of a group of subsets 108, 110 or 112. In particular, subsets 102a-g are part of group 108, subsets 102h and 102i are part of group 110 and subset 102j is part of group 112. Although only three groups are shown, an automation installation can include any number of groups. Furthermore, although in this embodiment subsets 102 are shown as belonging to a distinct group, in other embodiments any of subsets 102 may be a part of more than one group.

Each individual subset 102a-j can have one or more control devices 116 of the same or various types. In other words, each individual subset does not necessarily need to contain identical control devices 116 or any other identical components or execute the same process. Each subset 102a-j can be of any physical size and layout and can individually or in groups be controlled and monitored by the HMI 104. As shown, subsets 102a-g are of similar size and are smaller than subsets 102h and 102i, which are all in turn smaller than subset 102j. Further, although ten subsets 102 are shown, any other number of subsets may be used in automation installation 100.

Even if there are differences between each of the subsets 120, the HMI 104 may monitor and/or control each one of the subsets 102a-j. Subsets 120 need not be physically separated nor be mutually exclusive in organization

Control device 116 can be any device that can, for example, process, perform computations, relay information, identify itself or identify other control devices. Further, for example, control devices 116 can query and disseminate information to and from other devices which may include robots, directional valves, indicator switches, data collectors, other control devices, drive controllers, signal generators or HMIs. Control device 116 can be composed of, for example, any combination of the following: programmable logic controllers (PLCs), programmable automation controller (PACs), personal computer (PCs), microprocessors, robots, drives or fixed HMIs. Alternately, control device 116 could also be a computing resource, robot control system, or end effector control system such as those described in co-pending U.S. patent application Ser. No. 12/725,635 entitled “Industrial Communication System and Method,” filed on Mar. 17, 2010 and assigned to the assignee of this invention.

Control devices 116 can be programmed for a specific task or process and can contain information that is relayed to HMI 104 for monitoring purposes. One or more of control devices 116 can also receive information from HMI 104 for purposes of controlling other control devices 116 within subsets 102a-j. The universal application, however, does not require information about all of the subsets 102 of the automation installation 100. Instead, the universal application can receive or query subset information from the control devices 116 once they are connected to the HMI 104. The universal application may be designed to be compatible with various configurations of control devices 116, including, for example, centralized, partially centralized/decentralized, or completely decentralized control.

The HMI 104 can be connected to a connection device (not shown) that is assigned to one or more of subsets 102a-g. The connection device can be any device or connection port which is used to bridge communication between the HMI 104 and the individual subsets 102a-j or the control device(s) 116 therein. In some instances a connection device may be integrated into one or more of the control devices 116.

As discussed previously, the universal application can be developed such that it is compatible with any automation installation. For example, the HMI can be chosen and the universal application can be developed such that it operates with all potential combinations of communications mediums and protocols. This can be achieved by first utilizing a connection device which can bridge between the network type (medium) of the automation installation with the network type of the HMI 104.

Connecting to a different connection device can depend on both the network and the characteristics of the HMI 104 utilized. Connection devices can be, for example common industrial devices such as multi-port Ethernet switches, wired to wireless converters and even RJ45 to M12 adapters can be utilized. Each of these connection devices may, for example bridge physical devices of the same medium, convert protocols or even adapt separate mediums for common communication.

Apart from, for example, initial configuration of the HMI 104 (e.g. IP address setup, programming language selection etc.), once the universal application has been installed, subsequent configuration of the universal application may be unnecessary. The universal application is developed to account for differences in, for example, the type and quantity of the control devices 116, connection devices and associated networks.

HMI 104 can be, for example, connected to a connection device that is assigned to a certain group of subsets, such as subsets 102a-g. The connection can be a wired or wireless connection. The universal application can change its connection between each of subsets 102a-g with, for example, a user input without necessitating the physical relocation of the HMI 104. However, in some instances, the HMI 104 may be physically relocated in closer proximity to one of the subsets, because, for example, an operator cannot appropriately utilize HMI 104 if because of an obstructed line of sight.

After the universal application has been developed and installed the HMI 104 has been connected to subsets 102a-g, the universal application can query or receive specific information from the control devices 116 of any or all of subsets 102a-g as to what types and quantity of control devices 116 exist therein. In one example, the universal application can multiplex data where input and/or output destinations can be changed via variable values.

In another example, the operator can change the HMI's subset of control via a user input, which permits the operator to select which control device 116 the HMI 104 is connected to. In another example, the operator can change the currently assigned HMI 104 assignment of the HMI by physically plugging in or connecting to a different networked connection device.

HMI 104 can also be simultaneously connected to subsets 102h, 102i and/or 102j. When HMI 104 is connected to subsets 102a-g, HMI 104 can monitor subsets 102h, 102i and/or 102j without actually providing commands to control devices 116 located therein. For example, it may not be desirable for HMI 104 to provide commands to the control devices 116 because, for example, a subset may have a different network type, the HMI 104 may not be in close physical proximity to the subset or there may be safety restrictions. However, in other embodiments, HMI 104 can both monitor and control other subsets 102h, 102i and/or 102j while monitoring and controlling subsets 102a-g or HMI 104 can provide control of subsets 102h, 102i and/or 102j without monitoring.

Similar to the controlling and monitoring of subsets 102a-g, subsets 102h and 102i can be of similar physical size and layout and can individually be monitored and controlled by HMI 104. Again, HMI 104 can be, for example, connected to a connection device that is assigned to subsets 102h and 102i. While controlling and monitoring subsets 102h and 102i, the HMI 104 (as described above in connection with subsets 102a-g) may or may not be able to monitor and/or control other subsets within automation installation 100.

Similar to the controlling and monitoring of subsets 102a-g and subsets 102h and 102i, subset 102j can individually be monitored and controlled by HMI 104. Subset 102j is unique in physical size and layout as compared to subsets of subsets 102a-g and subsets 102h and 102i. Again, HMI 104 can be, for example, connected to a connection device that is assigned to subset 102j. While controlling and monitoring subset 102j, the HMI 104 (as described above in connection with subsets 102a-g) may or may not be able to monitor and/or control other subsets within automation installation 100.

FIG. 2 illustrates an automation illustration 200 according to another embodiment of the invention. The automation installation 200 includes four subsets 202a-d (collectively referred to as subsets 202) with control devices 216 with each of subsets 202a-d being individually monitored and/or controlled by one of four HMIs 204. Each HMI 204 has a universal application similar to that described in the previous embodiment. Unlike the previous embodiment where a single HMI 104 controls and/or monitors multiple subsets, in this embodiment, the multiple HMIs 204 can be connected to and control and/or monitor multiple subsets 202.

In this embodiment, HMIs 204 may be mobile so that they can be moved and connected to different subsets 202 as desired or required. Accordingly, for example, a small number of HMIs 204 can monitor and/or control a large number of subsets 202. In other embodiments, some or all of HMI 204 can be limited to its physical location

Employing a single universal application on multiple HMIs 204 does not necessarily dictate the organization of the subsets 202a-d (in size, layout or proximity). The universal application can be planned without regard to the subset organization for a particular automation installation. Although each subset 202a-d illustrated appears similar in size and layout, each subset 202a-d may be of a different structure. Each HMI 204 can, as discussed in previous embodiments be connected to a network 218a-d through a connection device. Networks 218a-d may be set up according to different protocols, the HMI 204 can be capable of connecting its own protocol to the protocol of the particular network 218a-d. For example, a converter, adapter, bridge, or other device can be used to permit the HMI 204 to communicate with a networking employing any protocol regardless of the protocol used in the HMI. Accordingly, the universal application can communicate with any of subsets 202.

Connection of one HMI to a different subset 202a-d may be changed via a user input to the HMI 204 itself or through physical or wireless reconnection of the HMI 204 to the connection device of another subset. If the change is through user input, the subsets 202a-d can be interconnected on a network (wired or wireless).

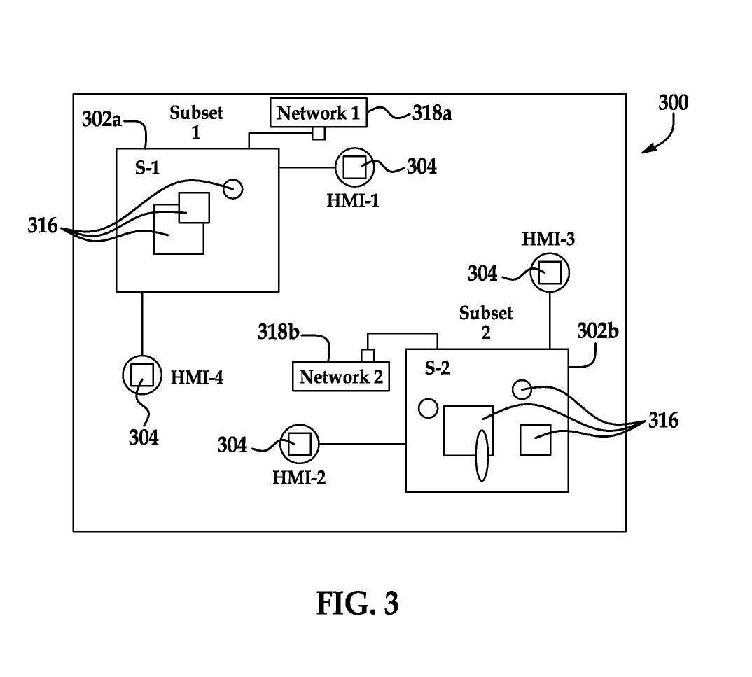

FIG. 3 illustrates an automation illustration 300 according to another embodiment of the invention. The automation installation 300 includes two subsets 302a and 302b (collectively referred to as subsets 302) with control devices 316 with each of subsets 302a and 302b being monitored and/or controlled by two of four HMIs 304. Each HMI 304 has a universal application similar to that described in the previous embodiments and can control multiple subsets 302 of automation installation 300.

In particular, more than one HMI 304 can simultaneously be connected to and communicate with an individual subset 302. This permits flexibility in automation installation 200 because, for example, any number of HMIs 304 can be supported. The universal application can be independent of other devices such that it does not rely on other HMIs 304 or their location for its own monitoring and control capabilities. If, for example, if restrictions are applied to an HMI 304 based on the presence of another HMI 304 then one or more of control devices 316 can be programmed to control this feature. In other words, the subset 302 can configure the operation of any connected HMI 304 and may permit the HMI 304 to connect to any connection device (through networks 318a-b). The HMI 304 may monitor and control the associated subset of devices to the extent that the control devices 316 allow. The universal application can be reliant on the control devices 316 rather than vice versa.

Additionally, the configured operation of a connected HMI 304 may change based on the location of the connected HMI 304 in relation to the subset that it is connected to. For example, the configuration of HMI-2 304 may differ from that of HMI-3 304 based upon their different relative location to subset 302b. This location may be detected in a number of different ways, including, for example, the particular connection box that each HMI is connected to.

As discussed previously, control device 316 can dictate level of control to the universal applications employed on HMIs 304 by, for example, setting a level of permissions. In this configuration, if one HMI 304 loses connection through, for example, intentional or accidental removal from the connection device, other HMIs 304 are not impacted beyond the granting of permissions from a control device 316.

The HMIs 304 illustrated can either be in fixed or movable If HMIs 304 are capable of mobility, they can, for example, be physically or wirelessly connected too or wirelessly connected to, connection devices on other subsets whilst maintaining the same level of control and monitoring of those subsets. As discussed previously, the level of control and monitoring can be dependent on the level of permissions given from control devices 316.

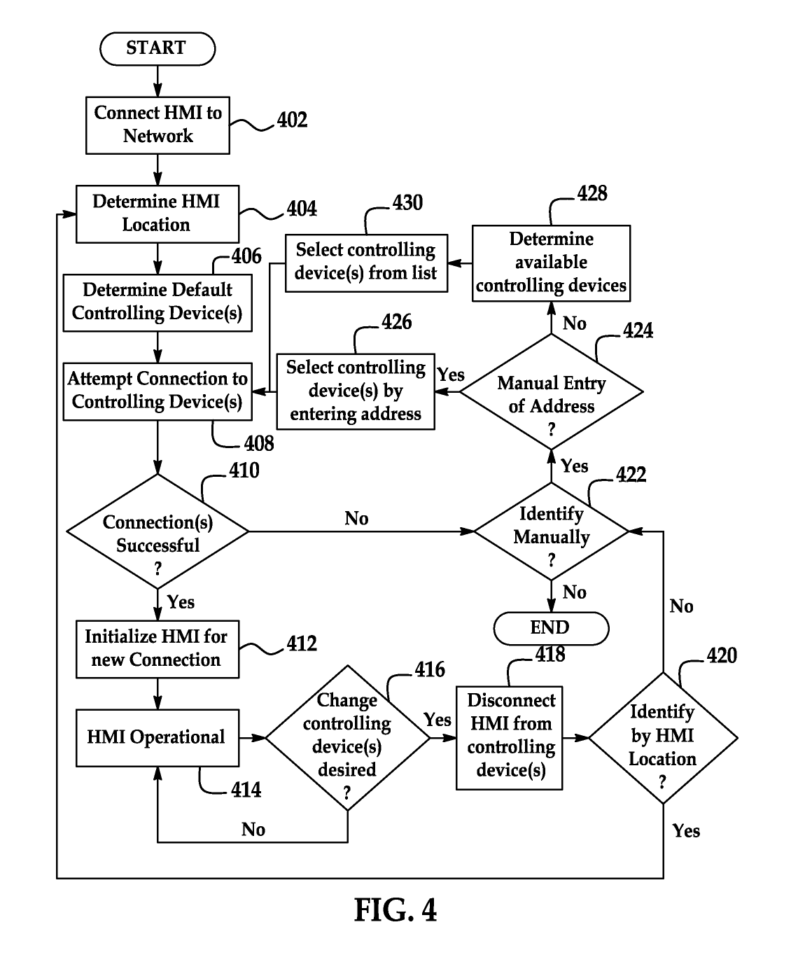

FIG. 4 illustrates a flowchart of a method of utilizing a universal HMI within an automation installation, such as those depicted in FIGS. 1-3. The method 400 represents one embodiment of the connection methodology used by the universal application to connect to control devices (e.g. control devices 116).

Starting with block 402, the HMI is connected to a network. As discussed earlier, this connection may be using wired or wireless technology. Alternately, the connection may be through a connection device associated with one or more control devices. Once the HMI is connected to the network, control passes to block 404, where the universal application determines the location of the HMI. The location may be determined in a variety of ways, including but not limited to: IP address subnet schemes, wireless access points or beacons, or the identifier of a connection device.

Once the HMI location is determined, the universal application determines a set of default control device(s) to connect with in block 406. The universal application may do this via a preconfigured list. Or the universal application, upon its first connection to a control device in the automation installation may download a list of control device(s) by location. Alternately, the universal application may scan the network for local control devices. Other alternatives for determining default control device(s) are also available.

The control device(s) can each be identified by a connection address. The address may be a standard network address such as an IP address or a MAC address. The address may alternatively be a specialized address, such as used in a PROFIBUS network. Or the connection address may be that of a connection device. Alternately, any other type of addressing scheme may be used for the purpose of uniquely identifying a control device.

After the control device(s) are determined, the universal application will attempt to connect to those control device(s) in block 408. The universal application will determine whether the connection(s) were successful in block 410. If connecting to more than one control device, the universal application may determine success as any one successful connection, some successful connections, or all connections being successful. The method of determining success may, for example, be pre-configured in the universal application or may potentially be determined by the control devices that were successfully connected to or by the location of the HMI.

If the connection(s) were not successful as determined above, control passes to block 422, which is described in more detail later. Otherwise, if the connection(s) were successful, control passes to block 412 to initialize the universal application of the HMI for the newly made connection(s).

Initialization of the HMI may include steps such as receiving user interface parameters from the connected control device(s). Such user interface parameters may determine which control and/or monitoring screens are to be generated by the universal application of the HMI. Such parameters may be merely instructive to the HMI (i.e. a template), from which the HMI will use to generate various screens for display on the HMI using graphics and/or subroutines built into the universal application. The HMI can generate screens using a combination of user interface parameters and pre-configured modules that are pre-existing on the HMI. However, it is also possible for the HMI to generate a screen or portion of a screen using only the user interface parameters.

For example, the control device may send parameters indicating that the HMI controls two clamps, a drilling machine, a robot, and a turntable. The parameters may indicate the, the numbers of devices, type of each device and specific characteristics of each device. Alternately, the parameters may define the characteristics of a particular type of device for the HMI if that type of device may not be defined in the HMI. The control device may also indicate other associated process information in the parameters such as, for example, the number of parts produced per machine cycle, the task time of the associated process, the number of production cycles, or the status of associated safety equipment, such as light screens.

From these parameters, the HMI may be configured to control various aspects of the process controlled by the control device (e.g. manually index the turntable, manually move the drilling machine up or down, or perform a specific operation with the robot). The HMI may also be configured by these parameters to, for example, display or collect information related to production quantities or the current position or status of each entity that the control device controls.

Alternately, the parameters may be a complete computer program or module that is used by the universal application as a “black box” for display on the HMI. Other combinations and alternatives are available for the construction of parameters to be delivered by control device(s) to the universal application.

Additionally, initialization of the HMI may include obtaining parameters from a control device such as downloading a list of other control devices. Such a list may include connection addresses of control devices within the same subset (e.g. subsets 102a-102g) as the connected control device. Alternately, the list may include one or more control devices within other subsets within the automation installation. The list may, for example, indicate to the HMI to automatically connect to one or more control devices on the list. Alternatively, some or all of the list may be used by the HMI for future reference and operation.

In any of the above or any other contemplated cases, the parameters provided to the HMI by the control device may be limited or varied based on the location of the HMI. For example, if the HMI is remote from the connected control device, some parameters may not be provided to the HMI or alternate parameters may be provided. Alternately, if the HMI is proximate to the control device, a full set of parameters may be provided.

Once initialized, the HMI becomes operational in block 414. While operational, the HMI may be used to monitor and/or control any control devices that it is connected to. During operation, the HMI checks to see if a change in controlling device(s) is desired in block 416. A change in control device(s) may be prompted, for example, by a change in physical location or by intervention of the user. Alternatively, the HMI or parameters sent to the HMI may trigger a change in control device(s). If no change is desired, the HMI remains operational in block 414.

However, if change in control device(s) is desired, the HMI disconnects from the control device(s) in block 418. Alternately, if the HMI is connected to more than one control device, the HMI may disconnect from only some of the control devices that it is connected to. Next, it is determined whether the change is a result of a change in physical location at block 420.

If the change is because of a change in physical location, control will return to block 404 for the HMI to detect the new location and subsequently determine a new set of default control device(s). Alternately, if the change in location includes the HMI removing its connection to the network (i.e. in the case of a wired connection), control would return to block 402 for re-connection of the HMI to the network.

However, if the change is not due to a physical location change, control moves to block 422. In addition, as mentioned previously, control may move to block 422 from block 410 in the event of unsuccessful connection to the default control device(s). At block 422, the HMI determines whether control device(s) can be identified manually. If not, the method ends. Although, alternatively, the method may enter a wait state to wait either for future manual input or a future change in location.

If block 422 determines that control device(s) can be identified manually, control moves to block 424. Block 424 determines whether or not one or more connection addresses of control devices will be entered by the HMI user. If one or more connection addresses will be entered in manually, control moves to block 426. At block 426, the control device(s) are selected by manual entry and control moves to block 408 to attempt connection to the selected control device(s).

Alternatively, if block 424 determines that there will be no manual entry, control moves to block 428. Block 428 determines a list of available control device(s) accessible to the HMI. This determination may be made using a pre-configured list in the HMI or by a list of control devices obtained by a previous connection to a control device. Alternately, the list may comprise of default control devices previously identified in block 406. The list may also include control devices identified by a scan of the network by the HMI. Other methods of determining a list of available control devices are possible.

Once a list of available control devices is determined by block 428, control moves to block 430 where the HMI user selects one or more control devices from the list. Once the selection is made, control passes to block 408 where a connection is attempted to the selected control device(s).

The above method is just one embodiment of the invention. It is understood that the steps of the method may be performed in a different order, that steps may be omitted, and additional steps may be added. For example, with respect to blocks 404, 406, 408, and 410, an alternate embodiment is contemplated. If, for example, the location of the HMI is not determinable at block 404, there may be no need to determine default control device(s) at block 406 and to attempt connection at block 408. In such a case, it may be desirable to move control to block 422 immediately in the event that a location is not determinable at block 404. In another embodiment, it may be desirable to default to a manual selection of control device(s), for example, starting the method at block 422 rather than automatically determining a set of default control device(s).

While the invention has been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed:

1. A method for operating a user interface in an automation installation, the method comprising:
identifying at least one control device;
establishing a connection between the user interface and the at least one control device; and
obtaining at least one user interface parameter from the at least one control device; and
generating at least one display screen on the user interface using the at least one user interface parameter.

2. The method of claim 1, wherein the at least one user interface parameter is at least one of a number, a type or a characteristic of a device controlled by the at least one control device.

3. The method of claim 1, further comprising:
selecting the at least one display screen from a plurality of display screens based on the at least one user interface parameter.

4. The method of claim 1, wherein the automation installation includes an alternative control device, further comprising:
obtaining at least one user interface parameter from the alternative control device; and
generating at least one other display screen on the user interface using the at least one user interface parameter from the alternative control device.

5. The method of claim 1, wherein identifying the at least one control device further comprises using at least one of:
entering an address corresponding to the at least one control device;
selecting the at least one control device from a list of available control devices; or
determining a location of the user interface and using the location to determine a the at least one control device.

6. The method of claim 5, wherein the location is determined using at least one of a network address, a specialized address or a connection device.

7. The method of claim 1, wherein the connection is at least one of a wireless connection or a wired connection.

8. The method of claim 1, further comprising:
selecting one or more graphics from a plurality of graphics based on the user interface parameter:
displaying the one or more graphics on the display screen.

9. The method of claim 1, wherein the user interface is one of movable or fixed.

10. The method of claim 1, wherein the at least one user interface parameter is stored on the at least one control device.

11. The method of claim 1, further comprising:
connecting the user interface to a network;
wherein at least one of identifying the at least one control device, establishing the connection, and obtaining the at least one user interface parameter are performed automatically once the user interface is connected to the network.

12. A user interface apparatus for use in an automation installation, comprising:
a memory; and
a processor configured to execute instructions stored in the memory to:
identify at least one control device;
establish a connection with the at least one control device; and
obtain at least one user interface parameter from the at least one control device; and
generate at least one display screen on the user interface using the at least one user interface parameter.

13. The apparatus of claim 12, wherein the at least one user interface parameter is at least one of a number, a type or a characteristic of a device controlled by the at least one control device.

14. The apparatus of claim 12, wherein the processor is further configured to execute instructions stored in the memory to:
select the at least one display screen from a plurality of display screens based on the at least one user interface parameter.

15. The apparatus of claim 12, wherein the automation installation includes an alternative control device and wherein the processor is further configured to execute instructions stored in the memory to:
obtain at least one user interface parameter from the alternative control device; and
generate at least one other display screen on the user interface using the at least one user interface parameter from the alternative control device.

16. An automation system, comprising:
at least one control device having at least one user interface parameter;
a user interface configured to accept the at least one user interface parameter from the at least one control device and generate at least one display screen using the at least one user interface parameter; and
a communications network configured to connect the at least one control device and the user interface.

17. The system of claim 16, further comprising:
a device controlled by the at least one control device.

18. The system of claim 17, wherein the at least one user interface parameter is at least one of a number, a type or a characteristic of the device.

19. The system of claim 17, wherein the at least one user interface parameter is stored on the at least one control device.

20. The system of claim 16, wherein the user interface is one of movable or fixed.
